(19) United States
(12) Patent Application Publication
(10) Pub. No.: US 2026/0019477 A1
(43) Pub. Date: Jan. 15, 2026

(54) METHOD FOR INTRA-STACK ZERO-COPY TRANSMIT PATH IN SHARED-MEMORY-BASED COMMUNICATION MODE

(71) Applicant: SHANGHAI JIAO TONG UNIVERSITY, Shanghai (CN)

(72) Inventors: Jian LI, Shanghai (CN); Pengze QIU, Shanghai (CN); Haibing GUAN, Shanghai (CN)

(21) Appl. No.: 19/083,144

(22) Filed: Mar. 18, 2025

Related U.S. Application Data
(63) Continuation-in-part of application No. PCT/CN2024/104880, filed on Jul. 11, 2024.

(51) Int. Cl. H04L 69/22; G06F 9/54; H04L 69/16

(52) U.S. Cl. CPC H04L 69/22; G06F 9/544; H04L 69/162

(57) ABSTRACT

The present invention discloses a method for an intra-stack zero-copy Tx path in a shared-memory-based communication mode and pertains to the field of data communication technology, in which copying from shared memory to packet buffers is replaced with writing references to data in the shared memory into the packet buffers, eliminating creating a copy of the data in the packet buffers. An original Tx path in a network protocol stack is remodeled into a zero-copy Tx path without any modification to the application side while maintaining transparency and loose coupling of the network protocol stack to upper-layer applications. This eliminates data copying within the network protocol stack and data replication in LLC memory, thereby reducing unnecessary LLC occupancy and improving the network protocol stack's network performance in large-file transfers under heavy load conditions.

### RELATED APPLICATIONS

This application is a continuation-in-part (CIP) application claiming benefit of PCT/CN2024/104880 filed on Jul. 11, 2024, the disclosure of which is incorporated herein in its entirety by reference.

### FIELD OF THE INVENTION

The present invention relates to the field of data communication technology, and more particularly to a method for an intra-stack zero-copy transmit (Tx) path in a shared-memory-based communication mode.

### DESCRIPTION OF THE PRIOR ART

Nowadays, people like to gain, share, and exchange information through short videos and streaming media. Accordingly, video streaming has become a considerable part of Internet traffic. For video platforms, the massive traffic means both big profits and great challenges. In order to address huge traffic, the platforms must provide sufficiently powerful software and hardware support.

Thanks to the rapid evolution of hardware in recent years, the performance of networking hardware is increasing, bringing about continuous bandwidth growth and the debut of 100 Gbps and 400 Gbps network interface cards (NICs). However, it has been found that the processing speed of existing upper-layer host software is approaching its limit to support hardware development and has become a bottleneck in further enhancing overall performance. Network protocol stacks are crucial for linking upper-layer applications with underlying networking hardware and therefore important to overall network performance.

In a simple video streaming scenario, clients may retrieve a large file from a server over long-lived connections. Traditional kernel-space network protocol stacks lack efficiency in such heavy-traffic, large-file transfers over long-lived connections. Use of kernel-space network protocol stacks for applications incurs overhead associated with, among others, context switches and data copying between the user and kernel spaces. For this reason, some researchers have begun to explore the possibility of replacing kernel-space network protocol stacks with user-space network protocol stacks for network performance enhancement.

User-space network protocol stacks are implemented in user-space processes, eliminating context switches between the user and kernel spaces. Moreover, the user-space programs can be more easily developed, tested and deployed than kernel-space programs, enabling faster upgrading and updating.

A user-space protocol stack is commonly implemented either as a Library OS (LibOS), or as a microkernel.

A LibOS user-space protocol stack is deployed in a single process together with associated applications, and utilizes function calls for network communication of the applications. Compared with traditional system calls, function calls are lighter and eliminate overhead associated with context switches. However, this approach leads to tight code coupling between the application and network protocol stack and requires development of a separate network protocol stack for a different set of applications. That is, a single network protocol stack can be poorly used among different types of applications. Moreover, the coupling binds up updates of the network protocol stack with the application programs, necessitating a complete restart of the process for any update or upgrade.

A microkernel user-space protocol stack is deployed in a separate process and communicates with associated external applications through shared memory to provide them with network services. This design features loose coupling of the network protocol stack with the applications and allows the network protocol stack to be more generally used with more applications. Moreover, the network protocol stack can be upgraded independently of the applications.

Since a microkernel user-space network protocol stack is separately deployed in a different process from that of associated applications, inter-process communication is necessary for it to provide the applications with network services. Inter-process communication is commonly based on shared memory, which, however, would introduce multiple data copies.

For example, in order to transmit data from an application to the network protocol stack, it is necessary to first copy the data from a private memory space of the application into shared memory before it can be accessed by the network protocol stack. After getting access to the data, the network protocol stack also has to assemble it into packets in packet buffers. To achieve this, the network protocol stack also needs to copy the data from the shared memory into the packet buffers, where the data is added with packet headers and converted into packets for transmission by an NIC.

In large-file transfer scenarios, data transfers are typically conducted in the form of very large chunks, and memory copying may take many CPU cycles. Therefore, overhead incurred by memory copying would prevail in these cases.

Nevertheless, analysis from the point of view of processor microarchitecture has revealed that, in addition to a great number of CPU cycles, considerable last-level cache (LLC) resources would also be consumed for memory copying in large-file transfer scenarios.

FIG. 1 shows transmission analysis of a conventional vector packet processing (VPP) network protocol stack. The Tx process begins with an application copying data from private memory of the application into shared memory and notifying the network protocol stack of this. In case of the Intel x86 architecture, the network protocol stack and associated applications may run on different CPU cores in a single socket and the CPU may cache data from shared memory into LLCs for sharing among the cores. The network protocol stack then copies the data from the shared memory into packet buffers, adds packet headers, and hands the processed data over to a driver. The driver constructs descriptors, writes them to a descriptor ring and notifies an NIC to send out the resulting packets through direct memory access (DMA). However, in order to address the ever-increasing network bandwidth growth, NICs are required to complete packet processing within an increasingly shorter time, and conventional memory accessing is considered to introduce too long delays. Catering to this, some manufacturers have equipped their NICs' I/O or other components with direct cache access (DCA) capabilities. For example, the Intel Data Direct I/O (DDIO) is capable of direct LLC access, which can reduce data reading and writing delays and provides increased throughput. Accordingly, the CPU can cache the packets in LLCs for access by the NIC.

From this analysis, it can be found that two copies of the data are created in the Tx path from the application to the network protocol stack, one of which is stored in the shared memory, and the other is added with packet headers and assembled into packets. Although the stored and encapsulated versions are of different structures, they are both essentially the Tx data from the application and occupy LLC memory. However, LLCs typically have limited memory. For example, LLC memory per socket of some general processors, such as the Intel Xeon series, is only tens of MB, much smaller than physical memory, and unscalable. Therefore, in case of large data transfers from an application, which themselves, let alone their multiple copies, would occupy much memory, the LLC memory may be soon taken up. When this happens, partial storage of the data or copies thereof in regular memory is inevitable. Consequently, more CPU cycles would be needed for memory copying and the NIC must wait longer for data reading from the memory. The slower memory copying and packet transmission from the NIC would slow down packet transmission from the network protocol stack and eventually degrade its performance.

An experiment has been carried out to investigate LLC usage by a network protocol stack and an associated application and the LLC miss rate of a network protocol stack CPU at different numbers of network connections, and the results are shown in FIGS. 2 and 3. According to the experiment results, LLC occupancy is significant when there are less than 400 network connections, and almost complete LLC occupancy occurs when the number increases to more than 400. At the same time, the LLC store miss rate of the network protocol stack surges from 12% to 80%. Most LLC storage of the network protocol stack is involved in memory copying from shared memory to packet buffers. An increase in LLC store miss rate will lead to memory copying introducing longer delays, which will slow down packet processing of the network protocol stack and degrade its network performance.

Therefore, those skilled in the art are directing their effort toward developing a method for an intra-stack zero-copy Tx path in a shared-memory-based communication mode, which can remodel an original Tx path in a network protocol stack into a zero-copy Tx path without any modification to the application side while maintaining transparency and loose coupling of the network protocol stack with upper-layer applications. This eliminates data copying within the network protocol stack and data replication in LLC memory, thus reducing unnecessary LLC occupancy and improving the network protocol stack's network performance in large-file transfers under heavy traffic conditions.

### SUMMARY OF THE INVENTION

In view of the above-described disadvantages of the prior art, the problem sought to be solved by the present invention is to eliminate memory copying in a Tx path within a network protocol stack by remodeling it into a zero-copy path. Memory copying may introduce LLC store misses and slow down packet processing. Eliminating memory copying can avoid intra-LLC data replication and the resulting LLC memory savings can be used for caching of additional Tx data, resulting in enhanced performance of the network protocol stack.

To this end, the present invention provides a method for an intra-stack zero-copy transmit (Tx) path in a shared-memory-based communication mode, characterized in comprising the steps of:
Step 1: receiving an I/O request from an application by polling an I/O event queue and then forwarding the request to a session module for processing, by an event polling module of a network protocol stack;
Step 2: after receiving the request, identifying a corresponding network session, identifying a data Tx queue based on information thereof recorded in the network session, determining a location and length of a Tx data, and then calling a memory coupling module and transferring the information of the Tx data to the memory coupling module, by the session module;
Step 3: after acquiring the information of the data from the Tx queue, calculating required packet buffer resources, allocating them from a pool of packet buffer resources and then storing references to the data in the packet buffers, by the memory coupling module, instead of copying the data into the packet buffers, as is conventional, wherein one more packet buffer is allocated;
Step 4: after the references are written in the packet buffers, handing the packet buffers over to the session module by the memory coupling module and in turn handing the packet buffers over to a transport/network layer for packet encapsulation by the session module;
Step 5: receiving a session information and the packet buffers from the session module and identifying a corresponding network connection, by the transport/network layer, and generating a packet header by the network protocol stack, wherein in order to enable ready ascertainment of whether a packet buffer stores a reference to data in shared memory, the network protocol stack stores the packet header in a separate packet buffer from those storing the data references and labels the packet buffers storing the data references; the network protocol stack pre-allocates one more packet buffer in Step 3 and writes the generated packet header into this reserved packet buffer; and the network protocol stack then concatenates the packet buffers storing the corresponding data references at the end of the packet buffer storing the packet header so that the set of packet buffers is together taken as a single encapsulated packet with scattered payloads;
Step 6: after the packet encapsulation is completed, notifying the event polling module by the session module of readiness of the packet buffers and notifying a network interface card (NIC) driver by the network protocol stack;
Step 7: retrieving the packet header from the packet buffer, or address and length information of the data in the shared memory, filling it into descriptors and placing them into a descriptor ring, by the NIC driver; for the concatenated packet buffers, the driver traverses them one by one, retrieves the information therefrom, fills the descriptors therewith and concatenates fields of the descriptors into a string of descriptors and writes it into the Tx descriptor ring; on an NIC which supports scatter/gather list (SGL) characteristics, based on the string of descriptors, the NIC reads the packet header and the data from the packet buffers and the data Tx queue, respectively, assembles them into a continuous packet within the NIC itself, and transmits the packet out; and after the transmission is completed, the NIC labels the string of descriptors as “done”;
Step 8: after the NIC driver receiving the done string of descriptors, handing the packet buffers over to a memory decoupling module by the network protocol stack; and
Step 9: checking the packet buffers one by one, deleting the reference information within the packet buffers for the labeled packet buffers that store the data references and thereby recovering them into regular packet buffers, and recycling them back into the pool of packet buffer resources, by the memory decoupling module.

Additionally, the method may be developed based on the open-source vector packet processing (VPP) user-space network protocol stack.

Additionally, upper-layer applications may communicate with the network protocol stack via shared memory to provide Web services to the outside.

Additionally, the network protocol stack may comprise the memory coupling module, the memory decoupling module and a memory management module.

Additionally, the memory coupling module may determine how many network packets data is to be split and then links the data in shared memory to packet buffers by performing traversing, preparing and linking steps on each network packet.

Additionally, in the traversing step, the number of blocks that the data spans may be counted, in each of which part of the data is stored as a segment thereof, and may serve as a basis for the memory coupling module to determine the number of packet buffer resources to be allocated.

Additionally, in the preparing step, the memory coupling module may allocate a set of packet buffers from the pool of packet buffer resources, the number of which is one more than the number of data segments counted in the traversing step, and reserve the first of the set of packet buffers for subsequent use by the transport/network layer for packet header addition.

Additionally, in the linking step, the memory coupling module may successively fill address and length information of the data segments acquired in the traversing step into the set of packet buffers, thereby linking the data in the shared memory to the packet buffers, and then points a “Next” of a previous packet buffer of the set of packet buffers to itself to link it in series to the preceding packet buffer, thereby forming a linked list.

Additionally, in Step 5, the network protocol stack may generate the packet header according to a network transfer protocol.

Additionally, information of the packet header generated by the network protocol stack in Step 5 may comprise the network connection and the length of the data.

In a Tx path, copying of data by a network protocol stack from shared memory into packet buffers creates two identical replicas of the data in the shared memory and the packet buffers, which both occupy LLC memory. In case of a large amount of the Tx data, the LLC memory may be completely occupied. This may lead to a great number of LLC store misses, which can degrade the performance of the network protocol stack. According to preferred embodiments of the present invention, a zero-copy Tx path is constructed in a network protocol stack to eliminate memory copying from shared memory to packet buffers, dispensing with creating a copy in the packet buffers. Instead, references to data in the shared memory are written into the packet buffers. In this way, data replication in the packet buffers is avoided.

Data in shared memory belongs to the application layer and is not compatible with the data structure of the underlying transport/network layer. For zero copying, a challenge is how to encapsulate data from the application layer and hand it over to an NIC for transmission. The present invention solves this by providing data reference support. Conventional integral packets are discretized, and NIC characteristics are leveraged to transmit such discretized packets. The data structure of packet buffers are expanded so that they are adapted to store only packet headers or data references. A number of packet buffers are linked in series according to the order of packet headers or data references into a linked list representing a discretized packet. Such discretized packets are handed over to an SGL-supporting NIC, which then integrates them back into continuous packets and sends them out.

Conventionally, after a network protocol stack completes a Tx task, the involved packet buffers will be immediately recycled back into a packet buffer pool. However, packet buffers now store references to data from the application layer, and depending on the reliability design of the transfer protocol used, it may be necessary to retain those data for final handling by a management unit of the shared memory. Therefore, another challenge is how to correctly recycle the packet buffers and handle the data they store. The present invention addresses this by adding a memory decoupling module, which decouples memory releasing of the application layer from that of the transport/network layer and ensures correct recycling of the memories. Before the packet buffers are handed over to a corresponding management unit for releasing and recycling, the memory decoupling module deletes the references from the packet buffers and decouples them from the shared memory. After this, management units for the packet buffers and the shared memory can then handle them separately.

Compared with the prior art, the present invention has the obvious substantive features and prominent advantages as follows:

1. It eliminates memory copying and hence LLC store misses that may otherwise result and degrade the performance of the network protocol stack. Therefore, improvements can be achieved in the performance of the network protocol stack. Moreover, LLC resources are exempted from occupancy by a data copy in packet buffers, and the problem of two identical data replicas in LLC memory is solved, resulting in LLC memory savings which can be used to cache more Tx data.

2. It couples shared memory to packet buffers and thereby allows for encapsulation of data into integral packets without any modification to the data structure of the application layer. The NIC can finally read packet headers directly from the transfer layer and data from the application layer and transmit them out in the form of packets

3. It avoids management logic coupling between packet buffers and data in shared memory. Thus, in addition to zero-copy transmission, correct data release of shared memory can be achieved.

4. It allows for faster processing of network packets by the network protocol stack. Moreover, the network protocol stack saves considerable CPU resources for memory copying as may be required by the processing of more network packets. Therefore, additional improvements can be achieved in the performance of the network protocol stack.

For a full understanding of the objects, features and effects of the present application, the concept, structural details and resulting technical effects will be further described with reference to the accompanying drawings.

### BRIEF DESCRIPTION OF THE DRAWINGS

FIG. 1 shows a Tx process of a VPP network protocol stack.

FIG. 2 shows LLC usage of an application and a VPP protocol stack as a function of the number of long-lived connections.

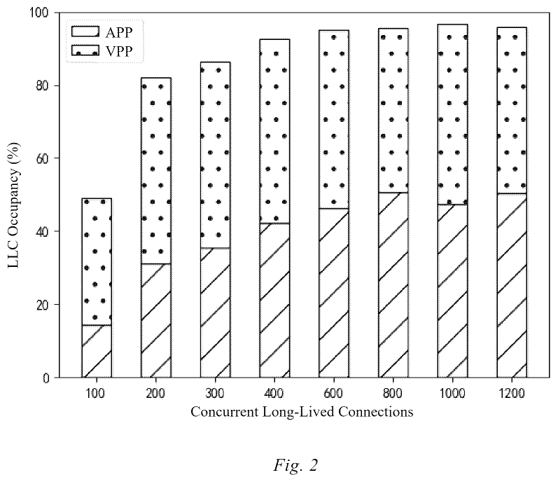

FIG. 3 shows an LLC miss rate of protocol stack CPU as a function of the number of long-lived connections.

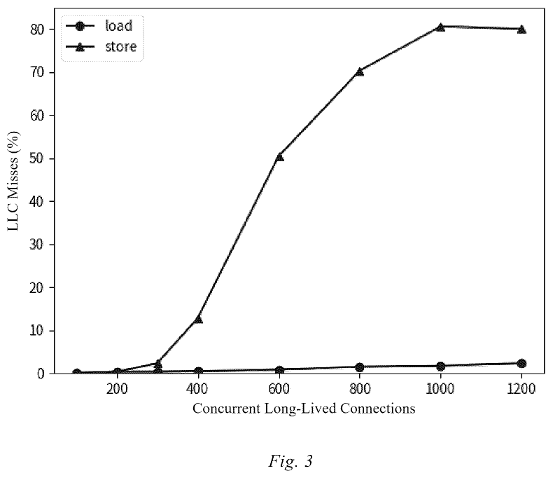

FIG. 4 shows a block diagram of an overall process.

FIG. 5 is a flowchart of a process performed by a memory coupling module.

FIG. 6 shows a Tx process performed through a zero-copy Tx path within a protocol stack.

### DETAILED DESCRIPTION OF THE PREFERRED EMBODIMENTS

A few preferred embodiments of the present application are described below with reference to the drawings accompanying so that the techniques disclosed herein become more apparent and better understood. The present application may be embodied in many different forms, and its scope sought to be protected hereby is not limited only to the embodiments disclosed herein.

Throughout the accompanying drawings, structurally identical parts are indicated with the identical reference numerals, and structurally or functionally similar components are indicated with similar reference numerals. In the drawings, the size and thickness of each component are arbitrarily depicted, and the present application is not limited to the size or thickness of any component. For greater clarity of illustration, the thicknesses of some parts may be exaggerated somewhere in the drawings.

Memory copying in a transmit (Tx) path creates two copies of Tx data, and LLC memory may be completely occupied in case of a large amount of the Tx data. When this happens, the network protocol stack would have to resort to partial copying into regular memory, leading to a great number of LLC store misses, which slow down packet processing. Accordingly, the problem sought to be solved by the present invention is to eliminate memory copying in a Tx path within a network protocol stack by remodeling it into a zero-copy path. Eliminating memory copying can avoid a reduced packet processing rate that may be otherwise caused by LLC store misses. Moreover, this can avoid intra-LLC data replication, and the resulting LLC memory savings can be used for caching of additional Tx data, resulting in enhanced performance of the network protocol stack.

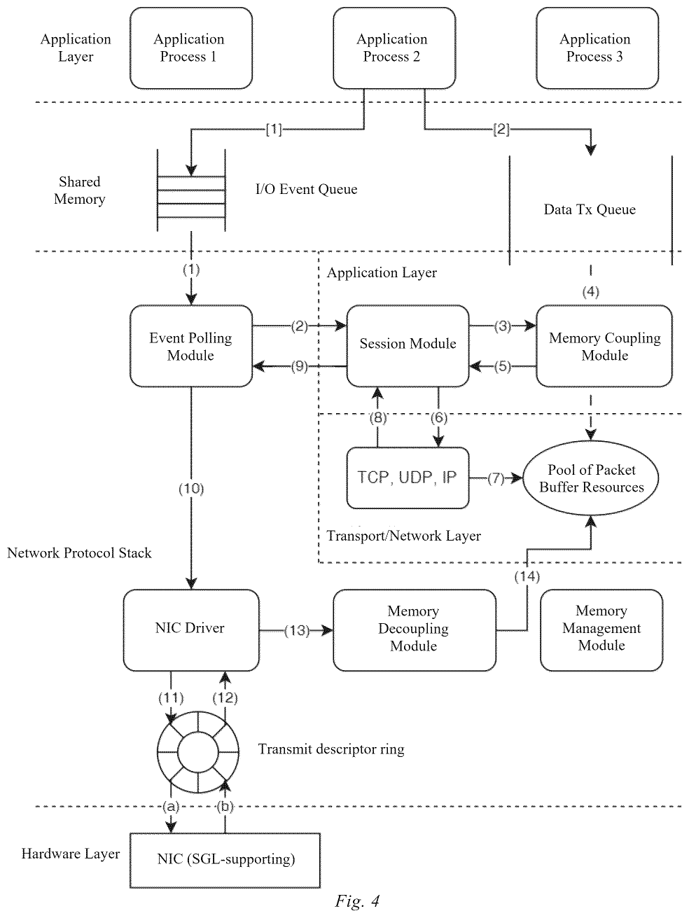

To this end, the present invention provides a method for an intra-stack zero-copy Tx path in a shared-memory-based communication mode. The present invention is developed based on the open-source vector packet processing (VPP) user-space network protocol stack. Upper-layer applications like Nginx communicate with the network protocol stack through shared memory to provide Web services to the outside. The network protocol stack includes a memory coupling module, a memory decoupling module and a memory management module, and the overall architecture is shown in FIG. 4.

On the upper-layer application-side, when an application calls a Tx port of a socket, a VPP library loaded into the application using LD_PRELOAD will translate the Tx call into a shared-memory-based inter-process communication including primarily the following two steps, as shown in FIG. 4.

[1]. Write a Tx event into an I/O event queue by the application, notifying the network protocol stack of the Tx request.

[2]. Copy data by the application from its own private memory into a data Tx queue for the shared memory, handing the data to the network protocol stack.

Zero copying on the application side means that it is necessary for the network protocol stack to read the data from the application's private memory and send it out.

This requires the application's private memory to be visible to the network protocol stack. This, however, would leave a chance for malicious applications to pollute memory space for the network protocol stack, or even that for other applications, through buffer overflow, creating security issues. On the other hand, reduced exposure of the application's private memory for increased security means that it is necessary for the application to share memory storing the Tx data with the network protocol stack, and to cancel the sharing on time after transmission of the data is completed. This requires the network protocol stack to modify a page table twice for each Tx task to create and delete shared memory. However, as any modification to the page table must be made within the kernel, modifying the page table for each Tx task would incur substantial overhead. For these reasons, in order to avoid the security risk arising from exposure of the application's private memory and huge overhead incurred by frequent page table modifications, the original application-side Tx logic based on memory copying is retained.

An overall Tx process of FIG. 4 performed on the side of the network protocol stack is described below.

(1) (2) An event polling module of the network protocol stack polls the I/O event queue to receive an I/O request from the application and then forwards the request to a session module for processing.

(3) In response to receipt of the Tx request, the session module identifies a corresponding network session, and then identifies a data Tx queue based on information thereof recorded in the network session. After that, it determines the location and length of the Tx data and calls the memory coupling module. Subsequently, it provides information of the Tx data to the memory coupling module, allowing the memory coupling module to process the data in the data Tx queue.

(4) After getting the information of the data in the Tx queue, the memory coupling module calculates necessary packet buffer resources. They are then allocated from a pool of packet buffer resources, and references to the data are then saved in the packet buffers, in place of the conventional practice of copying data into packet buffers. In this process, the module allocates one more packet buffer for use in step (7). This process performed by the memory coupling module will be described in greater detail below.

(5) (6) After writing the references into the packet buffers, the memory coupling module hands the set of packet buffers over to the session module. At this point, the packet buffers only contain the references that refer to the data from the application layer, and packet header addition according to an associated network transfer protocol is necessary for encapsulation. Accordingly, the session module hands the packet buffers over to the underlying transport/network layer for encapsulation.

(7) The transport/network layer receives the session information and packet buffers from the upper-layer session module and identifies a corresponding network connection. The network protocol stack generates a packet header according to the network transfer protocol based on the length of the data and other information. In order to enable ready ascertainment of whether a packet buffer stores a reference to data in the shared memory, the network protocol stack stores the packet header in a separate packet buffer from those storing the references and labels the packet buffers storing the references. This is the reason that the network protocol stack allocates one more packet buffer in advance in step (4). The network protocol stack writes the generated packet header into the reserved packet buffer and then concatenates the packet buffers storing the data references at the end of the packet buffer storing the packet headers so that this set of packet buffers can be collectively taken as an encapsulated packet with scattered payloads.

(8) (9) (10) After the packet capsulation, the session module notifies the event polling module of the readiness of the packet buffer, and the network protocol stack then notifies an associated NIC driver of that.

(11) The NIC driver retrieves the packet header from the packet buffers, or information of the data from the shared memory, such as addresses and length, fills descriptors therewith, and places them into a descriptor ring. In this process, the driver traverses the concatenated packet buffers, retrieves the information, fills the descriptors therewith, concatenates some fields of the descriptors into a string of descriptors, and writes it into a Tx descriptor ring.

(a) (b) The NIC is SGL-supporting and reads the packet header and data from the packet buffers and data Tx queue, respectively, according to the string of descriptors. It assembles them into a continuous packet within the NIC itself and then sends the packet out. After the transmission is completed, the NIC labels the string of descriptors as “done”.

(12) (13) Conventionally, when the NIC driver receives the string of descriptors that has been done, the network protocol stack would recycle the corresponding packet buffers back into the pool of packet buffer resources. However, since the packet buffers may now store references to the data in the shared memory, it is necessary to ensure that the memory space occupied by the data in the shared memory is correctly recycled. On the other hand, introducing data management of the upper-layer application layer into management logic for the pool of packet buffer resources will disrupt independence between the layers. In order to avoid memory management logic coupling between the application and transport/network layers, the network protocol stack hands the packet buffers to the memory decoupling module before recycling them into the pool of packet buffer resources.

(14) The memory decoupling module checks the packet buffers one by one. For any labeled packet buffer storing a data reference, the memory decoupling module deletes the reference information from the packet buffer, turning it into a regular packet buffer, which is then recycled into the pool of packet buffer resources.

As a key component in the network protocol stack, the memory coupling module eliminates copying from the shared memory into the packet buffers as required by conventional network protocol stacks. The elimination of this memory copying is expected to 1) retain the good layered design of the conventional VPP network protocol stack while preventing a tight coupling between the layers; and 2) enable data structure and function logic modifications to a certain layer at minimal performance cost.

In view of these considerations, the network protocol stack does not modify the data structure of the data Tx queue for the shared memory for compatibility with the data structure of the packet buffers, in order to avoid data-structure coupling between the application and transport/network layers. Also, it does not share the pool of packet buffer resources in the transport/network layer with the application layer for storage of data in the application layer. Accordingly, the memory coupling module is required to simultaneously encapsulate data in both the transport/network and application layers without copying and then hands the resulting packets over to the NIC for transmission. To this end, the data structure of the packet buffers in the transport/network layer is expanded to allow the packet buffers to reference memory space outside their own data structure. The data encapsulation is accomplished using the scatter/gather list (SGL) data structure.

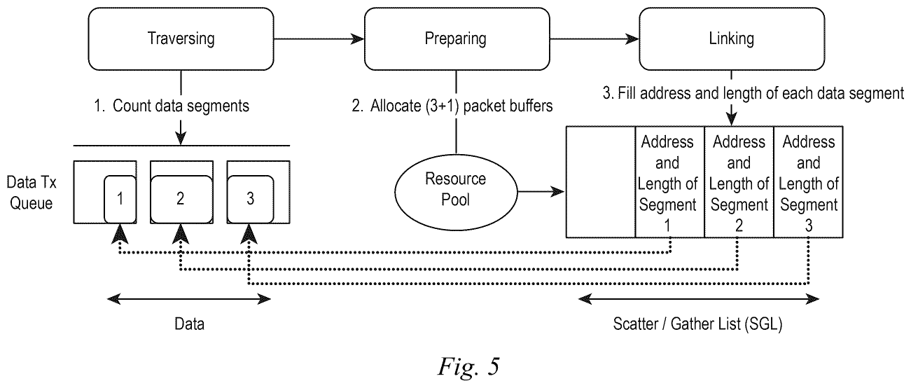

The memory coupling module is mainly responsible for: first determining how many Tx network packets data from the application is to be segmented, based on a length and packet MSS provided by the session module, wherein for the TCP protocol, a window size is also taken into account; and then performing traversing, preparing and linking steps on each network packet to link the data in the shared memory to the packet buffers. Specifically, the traversing, preparing and linking processes performed by the memory coupling module are as shown in FIG. 5.

(1) Traversing: The data Tx queue consists of a set of blocks organized into a linked list. Data storage spaces of the blocks are discontinuous, and the data written from the application may span multiple blocks. At first, based on the address and length information of the data, as well as on information of the blocks, the module traverses each block to count the number of blocks that the data spans. With data in each block being taken as a segment, the module thus determines how many packet buffer resources are to be allocated subsequently.

(2) Preparing: Next, the module allocates a set of packet buffers from the pool of packet buffer resources. The number of allocated packet buffers is one more than the number of data segments determined in step (1). The module reserves the first of the set of packet buffers for subsequent use by the transport/network layer to store a packet header.

(3) Linking: the module fills the address and length information of the data segments obtained in the traversing step, i.e., step (1), successively into the set of packet buffers, linking the data in the shared memory to the packet buffers. The module then points a “Next” of a previous packet buffer of the set of packet buffers to itself to link it in series to the previous packet buffer, thereby forming a linked list.

These packet buffers, together with the aforementioned packet buffer reserved for packet headers, make up an SGL representing a network packet that has not been encapsulated yet, and each element in the linked list points to a segment of the network packet.

After the memory coupling module completes the linking process, the SGL representing the non-encapsulated network packet is handed over to the underlying transport/network layer. A protocol processing node in the transport/network layer then traverses all the packet buffers in the linked list to acquire the length of the data. It then fills the network connection, length of the data and other necessary information into the packet header, creating an integral packet.

Subsequently, the driver traverses the set of packet buffers in the linked list and produces a descriptor for each packet buffer. Next, it configures the descriptors so that a “Next” of each descriptor points to the next descriptor, thereby obtaining a string of descriptors.

Afterwards, the string of descriptors is provided to the NIC, which leverages the characteristics of the SGL to obtain all the segments based on the address and length information. The NIC then assembles, within itself, the segments into a continuous network packet and transmits it out. Therefore, through expanding the data structure of packet buffers and using the SGL, an encapsulated integral network packet can be represented by a number of packet buffers while being actually stored at scattered physical memory locations, dispensing with data copying from the shared memory to the packet buffers. Additionally, with the aid of the SGL-supporting NIC, the network protocol stack can transmit data from the application layer out in the form of integral network packets, without involving copying of the data.

Conventionally, after the NIC transmits out the network packet in the packet buffers, the packet buffers can be immediately recycled back into the pool of packet buffer resources. In case of a transmitted network packet being lost, a reliable network connection like TCP would again copy the data from the application layer for retransmission. In contrast, in the zero-copy design described therein, as data in the shared memory in the application layer is directly taken as payload of network packets, in addition to data transmission, the network protocol stack must also take into account management and recycling of memory and packet buffers occupied by data.

During the management and recycling of the two types of resources, i.e., shared memory and packet buffers, the correctness of the following must be guaranteed: 1) recycling of packet buffers for subsequent normal use after correct transmission by the NIC; 2) timing of recycling data in shared memory, for example, after arrival of data from shared memory at the destination client is conformed, for reliable network transfer protocols such as TCP; and 3) maintenance of data in shared memory until the recycling for retransmission of correct data, whether the transport/network layer employs a reliable network transfer protocol or not.

In order to ensuring correctness while minimizing memory management logic coupling between the application and transport/network layers, the memory decoupling module is designed to manage and recycle data-linked packet buffers and shared memory after the NIC completes data transmission. The memory decoupling module is configured to handle references in packet buffers to data in shared memory before the packet buffers are recycled back into the pool of packet buffer resources, avoiding coupling of management logic for the pool of packet buffer resources with data management and recycling logic for the shared memory. Operation of the memory decoupling module is described below.

After transmitting out data in packet buffers, the NIC hands the packet buffers over to the memory decoupling module. The memory decoupling module then checks the packet buffers to identify labeled ones that store references to data in shared memory. After that, the memory decoupling module deletes the data references and de-labels the packet buffers, recovering the packet buffers into regular packet buffers empty of data references, which may be then recycled back into the pool of packet buffer resources. This not only ensures that the packet buffers can be recycled for reuse, but also ensures that, during reuse of the packet buffers by other functions of the network protocol stack, any modification made to the packet buffers will not alter data in the application layer, references to which were previously contained in the packet buffers.

In order to meet the reliability requirements of a certain network transfer protocol and ensure correct timing of data recycling, a callback function may be added to packet buffers. In the linking stage of the memory coupling module, different functions may be used as callback functions for packet buffers in various network transfer protocols and called by the memory decoupling module to determine whether to notify the application layer of data recycling depending on the network transfer protocol used. For example, for the TCP protocol, since it cannot be ensured that data transmitted by the NIC is surely received by the client, a corresponding callback function may be called to retain the data until an acknowledgement is received from the client. After that, the data can be recycled.

As payloads of network packets transmitted through the innovative Tx path are stored in shared memory, it is necessary to expand the original memory management module of the network protocol stack by adding direct memory access (DMA) mapping capabilities for managing the shared memory. Given that there are frequent Tx requests in heavy network traffic conditions, creating a DMA mapping for each piece of data and deleting the mapping after the data is transmitted out would lead to substantial overhead. Accordingly, when an application is activated, the memory management module may create an overall DMA mapping for the whole shared memory associated with the application. After the application is deactivated, the module may delete the DMA mapping for the shared memory. If the creation of such a DMA mapping fails due to limited resources in the system, for example, when the number of pages of the DMA mapping exceeds a predefined upper limit of the system, the shared memory may be labeled, and the session module may utilize the conventional approach to copy data from the shared memory into packet buffers.

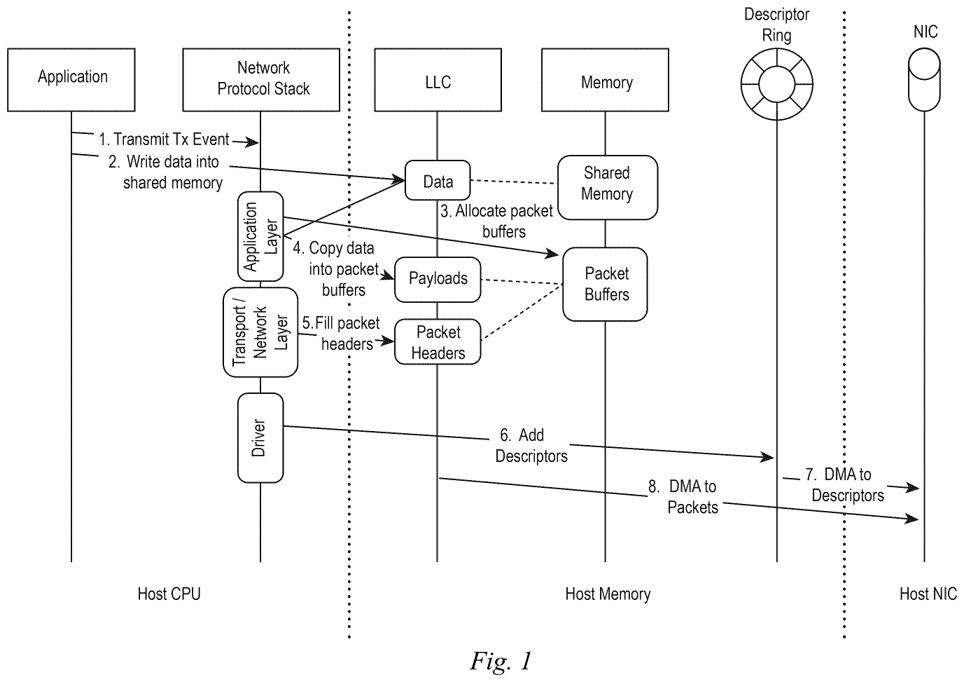

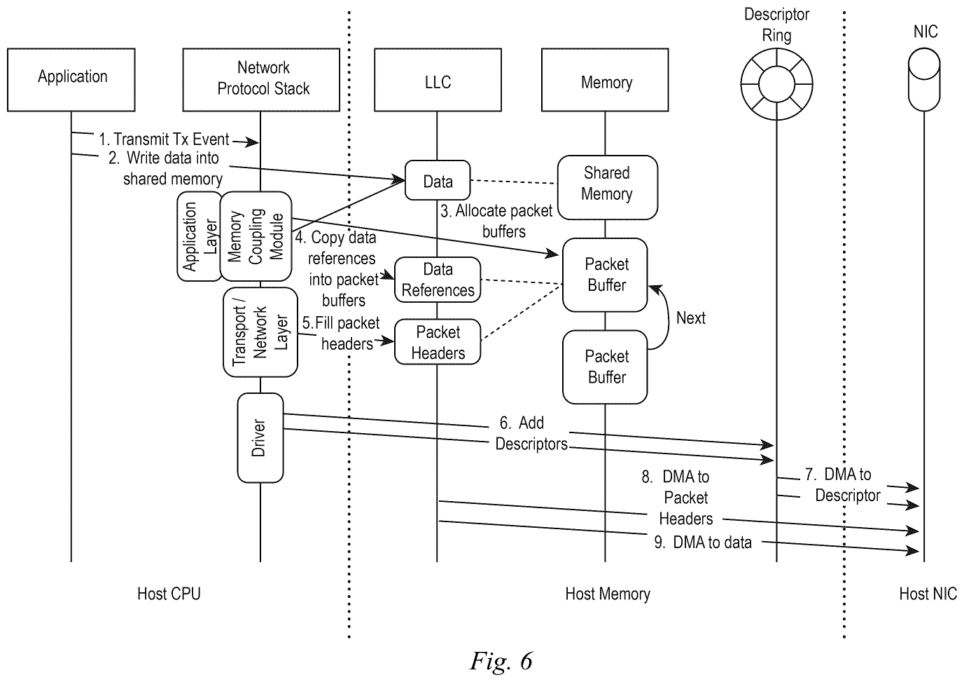

The present invention offers benefits as detailed below. FIG. 6 shows analysis of a process of transferring data from an application to a network protocol stack and then to an NIC through a zero-copy path remodeled from a Tx path in the network protocol stack. In Steps 1 and 2 of this process, data written into shared memory is cached in LLCs. These steps are the same as those in conventional process of FIG. 1. On the side of the network protocol stack, the memory coupling module allocates packet buffers and then writes references to the data in the shared memory into the packet buffers. Next, the network protocol stack generates a packet header for the data and writes it into another packet buffer. After that, the driver generates descriptors and writes them into a descriptor ring. After a DMA to the descriptors, the NIC further makes successive DMAs to the packet header and data. Compared with FIG. 1, although the transmission of each network packet requires the NIC to make multiple DMAs, the performance of existing NIC hardware is so powerful that collecting the scattered packet header and data into the NIC introduces only insignificant overhead even in large-file transfer scenarios, which does not considerably affect the NIC's performance and will not render the NIC a bottleneck in overall performance.

In this process, as can be seen, the shared memory and packet buffers also occupy LLC memory. However, compared with the approach of FIG. 1, through storing the references to the data, instead of the date itself, in the packet buffers, the network protocol stack saves substantial LLC resources because the data references occupy only a minimal part of the resources (as the allocated packet buffers will be used by a single thread of the network protocol stack, the data references may be even cached in L1 or L2 caches). Therefore, savings of LLC resources can be achieved. Further, as the network protocol stack no longer needs to write considerable data into LLCs, the problem of a great number of LLC store misses that may arise from memory copying is circumvented, speeding up network packet processing of the network protocol stack. Furthermore, due to elimination of memory copying, the use of the network protocol stack can result in considerable savings of CPU resources, which can be used for processing of more network packets, improving the performance of the network protocol stack.

Although a few preferred specific embodiments of the present application have been described in detail above, it will be understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A method for an intra-stack zero-copy transmit (Tx) path in a shared-memory-based communication mode, characterized in comprising the steps of:
Step 1: receiving an I/O request from an application by polling an I/O event queue and then forwarding the request to a session module for processing, by an event polling module of a network protocol stack;
Step 2: after receiving the request, identifying a corresponding network session, identifying a data Tx queue based on information thereof recorded in the network session, determining a location and length of a Tx data, and then calling a memory coupling module and transferring the information of the Tx data to the memory coupling module, by the session module;
Step 3: after acquiring the information of the data from the Tx queue, calculating required packet buffer resources, allocating them from a pool of packet buffer resources and then storing references to the data in the packet buffers, by the memory coupling module, instead of copying the data into the packet buffers, as is conventional, wherein in this process, one more packet buffer is allocated;
Step 4: after the references are written in the packet buffers, handing the packet buffers over to the session module by the memory coupling module and in turn handing the packet buffers over to a transport/network layer for packet encapsulation by the session module;
Step 5: receiving a session information and the packet buffers from the session module and identifying a corresponding network connection, by the transport/network layer, and generating a packet header by the network protocol stack, wherein in order to enable ready ascertainment of whether a packet buffer stores references to data in shared memory, the network protocol stack stores the packet header in a separate packet buffer from those storing the data references and labels the packet buffers storing the data references; the network protocol stack pre-allocates one more packet buffer in Step 3 and writes the generated packet header into this reserved packet buffer; and the network protocol stack then concatenates the packet buffers storing the corresponding data references at the end of the packet buffer storing the packet header so that the set of packet buffers is together taken as a single encapsulated packet with scattered payloads;
Step 6: after the packet encapsulation is completed, notifying the event polling module by the session module of readiness of the packet buffers, and notifying a network interface card (NIC) driver by the network protocol stack;
Step 7: retrieving the packet header from the packet buffer, or address and length information of the data in the shared memory, filling it into descriptors and placing them into a descriptor ring, by the NIC driver; for the concatenated packet buffers, the driver traverses them one by one, retrieves the information therefrom, fills the descriptors therewith and concatenates fields of the descriptors into a string of descriptors and writes it into the Tx descriptor ring; on an NIC which supports scatter/gather list (SGL) characteristics, based on the string of descriptors, the NIC reads the packet header and the data from the packet buffers and the data Tx queue, respectively, assembles them into a continuous packet within the NIC itself, and transmits the packet out; and after the transmission is completed, the NIC labels the string of descriptors as “done”;
Step 8: after the NIC driver receiving the done string of descriptors, handing the packet buffers over to a memory decoupling module by the network protocol stack; and
Step 9: checking the packet buffers one by one, deleting the reference information within the packet buffers for the labeled packet buffers that store the data references and thereby recovering them into regular packet buffers, and recycling them back into the pool of packet buffer resources, by the memory decoupling module.

2. The method of claim 1, characterized in being developed based on the open-source vector packet processing (VPP) user-space network protocol stack.

3. The method of claim 1, characterized in that upper-layer applications communicate with the network protocol stack via shared memory to provide Web services to the outside.

4. The method of claim 1, characterized in that the network protocol stack comprises the memory coupling module, the memory decoupling module and a memory management module.

5. The method of claim 1, characterized in that the memory coupling module determines how many network packets data is to be split and then links the data in shared memory to packet buffers by performing traversing, preparing and linking steps on each network packet.

6. The method of claim 5, characterized in that, in the traversing step, the number of blocks that the data spans is counted, in each of which part of the data is stored as a segment thereof, and serves as a basis for the memory coupling module to determine the number of packet buffer resources to be allocated.

7. The method of claim 5, characterized in that, in the preparing step, the memory coupling module allocates a set of packet buffers from the pool of packet buffer resources, the number of which is one more than the number of data segments counted in the traversing step, and reserves the first of the set of packet buffers for subsequent use by the transport/network layer for packet header addition.

8. The method of claim 5, characterized in that, in the linking step, the memory coupling module successively fills address and length information of the data segments acquired in the traversing step into the set of packet buffers, thereby linking the data in the shared memory to the packet buffers, and then points a “Next” of a previous packet buffer of the set of packet buffers to itself to link it in series to the preceding packet buffers, thereby forming a linked list.

9. The method of claim 1, characterized in that, in Step 5, the network protocol stack generates the packet header according to a network transfer protocol.

10. The method of claim 1, characterized in that information of the packet header generated by the network protocol stack in Step 5 comprises the network connection and the length of the data.
